(19) United States
(12) Patent Application Publication
(10) Pub. No.: US 2026/0113650 A1
(43) Pub. Date: Apr. 23, 2026

(54) CHANNEL STATE FEEDBACK IN DISCONTINUOUS RECEPTION CYCLE

(71) Applicant: QUALCOMM Incorporated, San Diego, CA (US)

(72) Inventors: Kiran VENUGOPAL, Green Brook, NJ (US); Yu ZHANG, San Diego, CA (US); Jing SUN, San Diego, CA (US); Yan ZHOU, San Diego, CA (US)

(21) Appl. No.: 18/918,631

(22) Filed: Oct. 17, 2024

(51) Int. Cl. H04W 24/10; H04W 76/28

(52) U.S. Cl. CPC H04W 24/10; H04W 76/28

(57) ABSTRACT

Certain aspects of the present disclosure provide techniques for communication of channel state information during a discontinuous reception cycle. An example method for wireless communications by a user equipment (UE) includes obtaining an indication to report channel state information (CSI), wherein the indication to report the CSI further indicates that communication of the CSI is allowed during an inactive time period of a discontinuous reception (DRX) cycle, and wherein the indication to report the CSI further indicates that communication of the CSI is independent of an on-duration timer associated with the DRX cycle; obtaining one or more reference signals; and sending, during an instance of the inactive time period, a report that includes first CSI based at least in part on the one or more reference signals.

### FIELD OF THE DISCLOSURE

Aspects of the present disclosure relate to wireless communications, and more particularly, to techniques for communication of channel state information.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining an indication to report channel state information (CSI), wherein the indication to report the CSI further indicates that communication of the CSI is allowed during an inactive time period of a discontinuous reception (DRX) cycle, and wherein the indication to report the CSI further indicates that communication of the CSI is independent of an on-duration timer associated with the DRX cycle; obtaining one or more reference signals; and sending, during an instance of the inactive time period, a report that includes first CSI based at least in part on the one or more reference signals.

Certain aspects provide a method for wireless communications by a network node. The method includes sending an indication to report CSI, wherein the indication to report the CSI further indicates that communication of the CSI is allowed during an inactive time period of a DRX cycle, and wherein the indication to report the CSI further indicates that communication of the CSI is independent of an on-duration timer associated with the DRX cycle; sending one or more reference signals; and obtaining, during an instance of the inactive time period, a report that includes first CSI based at least in part on the one or more reference signals.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment.

FIGS. 4A, 4B, 4C, and 4D depict various example aspects of data structures for a wireless communications network.

FIG. 5 depicts an example of a discontinuous reception (DRX) configuration.

FIG. 6 depicts an example scheme for communication of channel state information during a DRX cycle.

FIG. 7 depicts a process flow for communication of channel state information during a DRX cycle.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for communication of channel state information during a discontinuous reception cycle.

Certain wireless communication systems (e.g., a 5G New Radio (NR) system) may implement various power saving techniques. Two example power saving techniques include discontinuous reception (DRX) and discontinuous transmission (DTX). DRX provides a way for a wireless communication device, such as a user equipment (UE) or a network entity (e.g., a base station), to save power during a periodic off duration (also referred to as an inactive time period or non-active time period) in which the wireless communication device does not perform some forms of communication. During a periodic on duration, the wireless communication device performs communications (such as by monitoring a physical downlink control channel (PDCCH) for DRX or sending an uplink transmission for DTX). DTX may provide for transmission operations of the network entity to be deactivated during some time intervals. At the network entity, DTX may be referred to as “cell DTX”, and DRX may be referred to as “cell DRX.” Thus, the network entity may cease or restrict transmission and/or reception in certain time intervals in accordance with cell DTX and/or cell DTX (collectively referred to herein as “cell DTX/DRX”). Cell DTX/DRX may allow the network entity to enter a low power state such as a sleep state in a time interval, so long as communications to and from the network entity can successfully be avoided in the time interval. Thus, cell DTX/DRX may be referred to as a network energy saving technique.

A UE may implement a connected-mode DRX (C-DRX) cycle while the UE is connected to a network entity. In a C-DRX cycle, the UE may periodically enter an on duration and monitor a PDCCH. If the UE detects a PDCCH in the on duration, the UE may extend the on duration in accordance with a DRX inactivity timer, and may continue to monitor for further PDCCHs or perform other communications while in an active state. After the DRX inactivity timer has expired (or if the UE does not detect any PDCCH in the DRX on duration), the UE may enter a sleep state during an off duration. In the sleep state, some circuitry of the UE, such as radio frequency circuitry or a receive chain, may be powered down or in a low power state. Upon reaching a next DRX on duration, the UE may power up the circuitry and monitor for a PDCCH.

A C-DRX cycle may be configured using various parameters. For example, the DRX inactivity timer defined above may indicate how long a DRX on duration is extended when a PDCCH is received in the DRX on duration. As another example, a slot offset may indicate a slot in which a DRX on duration of the C-DRX cycle is to start with respect to the beginning of a subframe. As another example, a DRX cycle length may indicate a length of time from the start of a DRX on duration to a start of a next DRX on duration. As another example, a hybrid automatic repeat request (HARQ) round-trip time (RTT) timer and a HARQ retransmission timer may indicate time intervals associated with retransmission of a communication during a DRX cycle. These parameters may generally be configured via semi-static signaling, such as radio resource control (RRC) signaling.

Technical problems for a DRX cycle may include, for example, effective communication of channel state information (CSI) during the DRX cycle. Closed-loop feedback associated with a communication channel may be used to dynamically adapt certain communication parameters (e.g., modulation and coding scheme, beamforming, multiple-input and multiple-output (MIMO) layers, or the like) according to time varying channel conditions, for example, due to changes with respect to UE mobility, weather conditions, scattering, fading, interference, noise, etc. A UE may be configured to report CSI in specific scenarios during the DRX cycle. In certain cases, a UE may be configured to send a CSI report only if a CSI reference signal (CSI-RS) is communicated during the active time period of the DRX cycle. The network entity may align CSI-RS transmissions with the active time period of the DRX cycle. However, when several UEs in the coverage area of a network entity have DRX cycles enabled, aligning the CSI-RS transmissions with the active time period of each UE may not be possible, for example, due to the non-trivial amount of signaling overhead used for CSI-RS transmissions and the active time periods of the DRX cycles of certain UEs not overlapping in time with each other.

In certain cases, a UE may be configured to send periodic CSI during the duration associated with a DRX on-duration timer when the DRX on-duration timer is not started and certain power saving features are configured (such as a wake-up signal that indicates to monitor the downlink control channel during the active time period). A non-trivial amount of time may occur between an instance of the CSI report being communicated and communication of downlink traffic. For example, the channel conditions for communications between the UE and the network entity may change after the CSI report is communicated, for example, due to UE mobility or the like. The UE and the network entity may become misaligned in terms of the reported channel state and the current channel conditions, which may lead to beam failure and/or radio link failure. Accordingly, the UE may encounter interruptions in communications with the network entity to perform certain recovery procedures, such as beam failure recovery and/or radio link failure recovery, during instances of a DRX cycle.

Aspects described herein may overcome the aforementioned technical problem(s), for example, by providing certain schemes for communication of CSI during an inactive time period of a DRX cycle. Communication of CSI during the inactive time period may enable the CSI to be up-to-date when the network entity communicates with the UE during the active time period of the DRX cycle, for example, via a wake-up signal and/or control signaling (such as downlink control information). In certain aspects, the UE may obtain a configuration that indicates to report the CSI during the inactive time period of the DRX cycle. In certain aspects, the configuration may indicate the metric(s) to include in the CSI, the time at which to report the CSI, and/or the reference signal(s) to measure to determine the CSI.

Certain techniques for communication of CSI during a DRX cycle described herein may provide various beneficial technical effects and/or advantages. The techniques for communication of CSI during a DRX cycle may enable improved wireless communications performance, such as reduced latencies, reduced interruption times, reduced channel usage, and/or the like. The reduced latencies and/or reduced interruption times may be attributable to allowing CSI to be communicated during the inactive time period of a DRX cycle. In certain cases, the UE may be configured to report the CSI relatively close in time to the start of the active time period of the DRX cycle. In such cases, the CSI may be up-to-date for any downlink communications during the active time period, such as paging or downlink traffic. In certain cases, the UE may be configured to report periodic CSI during the inactive time period of the DRX cycle, enabling reliable and/or consistent CSI for any downlink communications during the active time period. In certain cases, the UE may be configured to measure CSI-RS transmissions communicated for multiple UEs. Accordingly, the CSI-RS resources may be shared among multiple UEs to measure the respective channel conditions and reduce the channel usage of CSI-RS transmissions.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

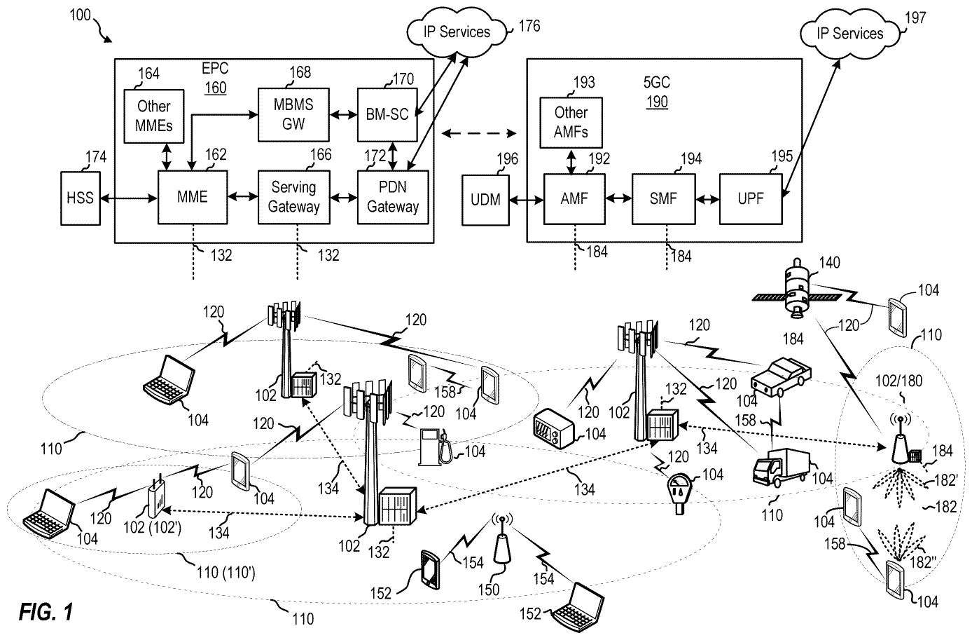

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

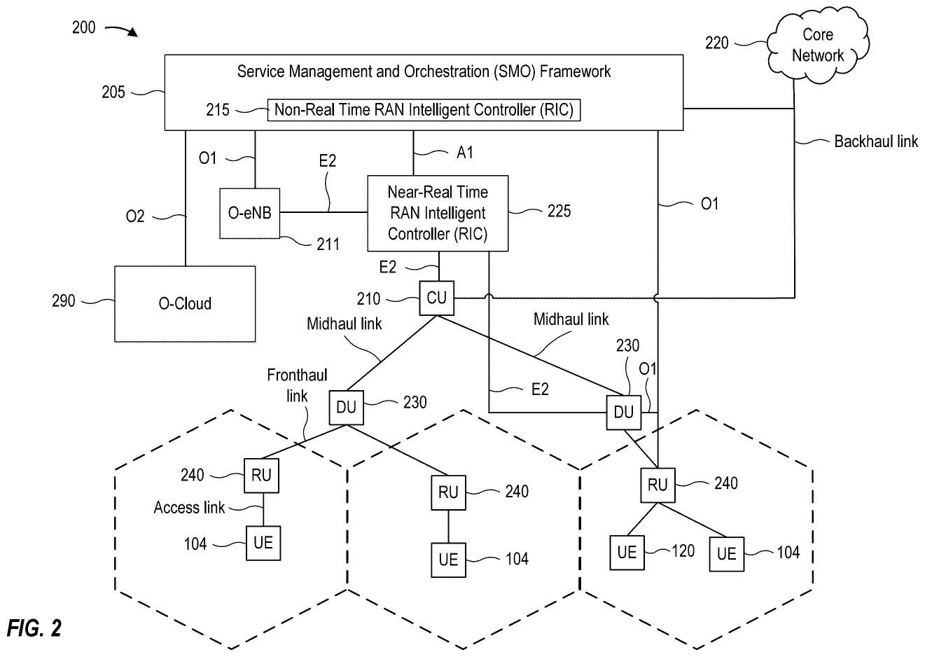

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit - User Plane (CU-UP)), control plane functionality (e.g., Central Unit - Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

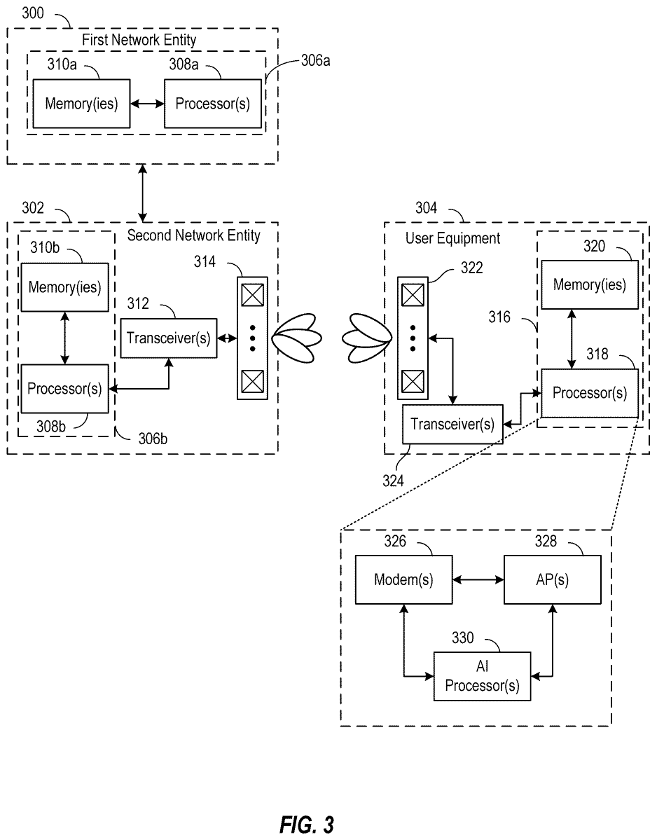

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

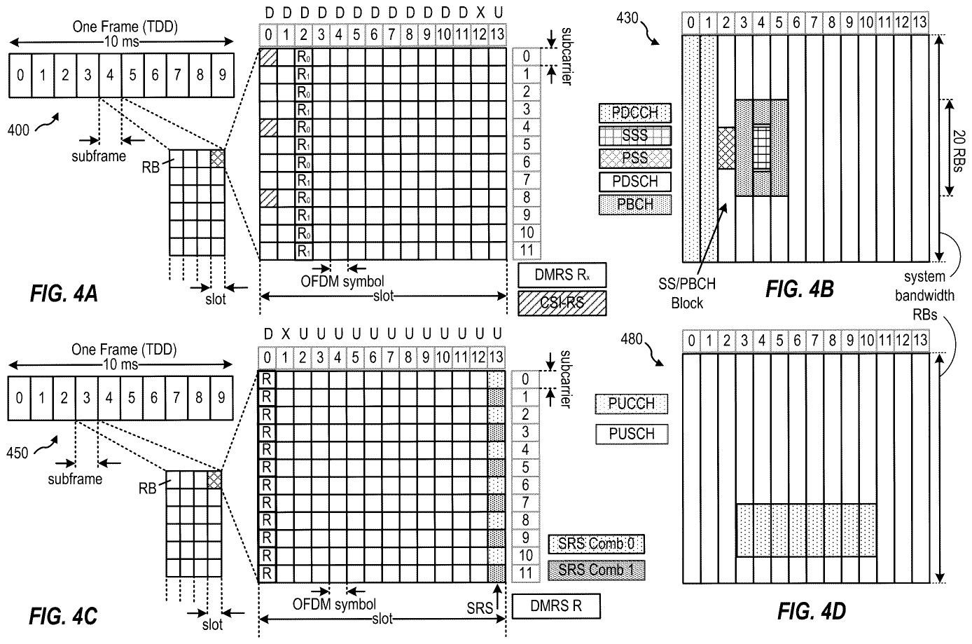

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Discontinuous Reception Cycle

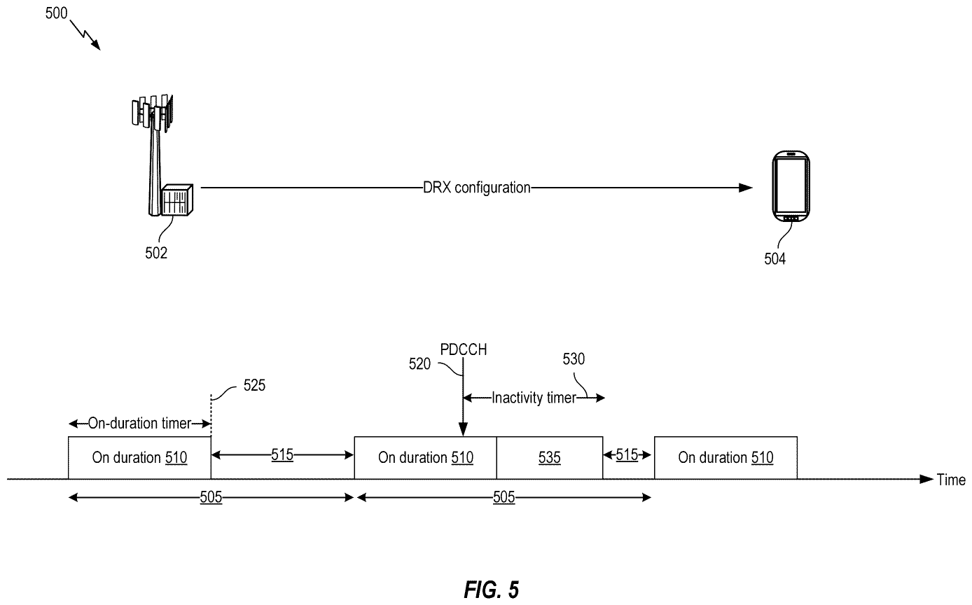

FIG. 5 depicts an example 500 of a DRX configuration. As shown, a network entity 502 may transmit, and a UE 504 may receive, a DRX configuration. The network entity 502 may be an example of the BS 102 of FIG. 1, the first network entity 300 or the second network entity 302 of FIG. 3, or a disaggregated base station as discussed with respect to FIG. 2. The UE 504 may be an example of the UE 104 of FIG. 1 or UE 304 of FIG. 3. The DRX configuration may be communicated via RRC signaling, MAC signaling, DCI, system information, and/or the like.

The DRX configuration may configure a DRX cycle 505. A DRX cycle 505 may include a DRX on duration 510 (for example, during which a UE 504 is awake or in an active state) and an opportunity to enter a DRX sleep state 515. The time during which the UE 504 is configured to be in an active state during the DRX on duration 510 plus any extension of the DRX on duration 510 (for example, due to an inactivity timer) may be referred to as an active time period of the DRX cycle 505. The time during which the UE 504 is configured to be in the DRX sleep state 515 may be referred to as an inactive time period (or a DRX off duration) of the DRX cycle 505. The UE 504 may monitor a downlink control channel (for example, a PDCCH) during the active time period, and the UE 504 may refrain from monitoring the downlink control channel during the inactive time period. In certain cases, the UE 504 may enter a lower power state during the inactive time period. Thus, the DRX cycle 505 may enable power savings at the UE 504, for example, due to periodic monitoring of the downlink control channel.

During the DRX on duration 510, the UE 504 may monitor a control channel, such as the PDCCH. For example, the UE 504 may monitor the control channel for control information (for example, DCI) pertaining to the UE 504. If the UE 504 does not detect and/or successfully decode any control channel communications addressed to the UE 504 during the DRX on duration 510, then the UE 504 may enter the sleep state 515 (for example, for the inactive time period) at the end 525 of the DRX on duration 510. In this way, the UE 504 may conserve battery power and/or reduce power consumption. As shown, the DRX cycle 505 may repeat with a configured periodicity according to the DRX configuration.

If the UE 504 detects and/or successfully decodes a control channel communication 520 addressed to the UE 504, then the UE 504 may remain in an active state (for example, awake) for the duration of a DRX inactivity timer 530 (for example, which may extend into the configured inactive time period of the current DRX cycle). The DRX inactivity timer 530 may be referred to herein as a timer parameter. The time period 535 depicts the extension of the active time period due to the DRX inactivity timer 530 being initiated. The UE 504 may start the DRX inactivity timer 530 at a time at which the control channel communication is received (for example, in a transmission-time-interval in which the control channel communication 520 is received, such as symbol, a slot, or a subframe). The UE 504 may remain in the active state until the DRX inactivity timer 530 expires, at which time the UE 504 may enter the sleep state 515 (for example, for the remainder of the inactive time period of the current DRX cycle). During the duration of the DRX inactivity timer 530, the UE 504 may continue to monitor for control channel communications, may obtain a downlink data communication (for example, on a data channel such as a PDSCH) scheduled by the control channel communication, and/or may prepare and/or transmit a communication (for example, on a PUSCH and/or a PSSCH) scheduled by the control channel communication. The UE 504 may restart the DRX inactivity timer 530 after each detection of a control channel communication for the UE 504 for an initial transmission (for example, but not, in some cases, for a retransmission). By operating in this manner, the UE 504 may conserve battery power and reduce power consumption by entering the sleep state 515.

### Aspects Related to Channel State Feedback in a DRX Cycle

Aspects of the present disclosure provide certain schemes for communication of CSI during an inactive time period of a DRX cycle. Communication of CSI during the inactive time period may enable reduced latencies, reduced interruption times, improved channel usage, and/or the like.

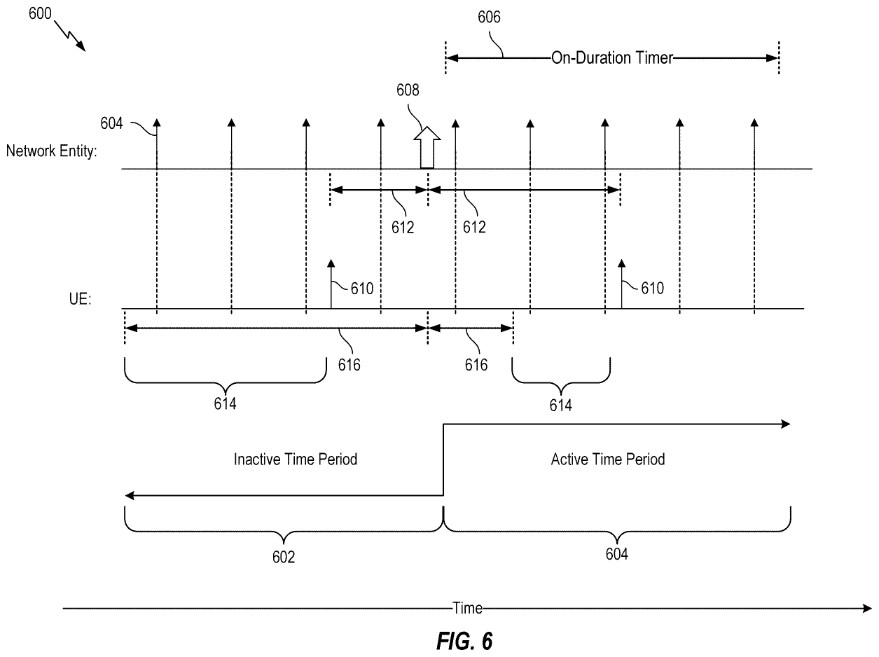

FIG. 6 depicts an example scheme 600 for communication of CSI during a DRX cycle. In this example, a UE (e.g., the UE 504) may be configured with a DRX cycle, for example, as described herein with respect to FIG. 5. With respect to FIG. 6, an instance of an inactive time period 602 of a DRX cycle is arranged adjacent to an instance of an active time period 604 of a subsequent DRX cycle. A network entity (e.g., the network entity 502) may send one or more reference signals including, for example, SSB(s), DM-RS(s), CSI-RS(s), and/or the like. The UE may obtain the reference signal(s) according to configuration(s) as further described herein

The UE may obtain one or more CSI configuration(s) that indicate to report CSI during the inactive time period 602 of the DRX cycle (for example, outside of the active time period 604 of the DRX cycle). The CSI configuration(s) may be or include, for example, a CSI report configuration, a power saving configuration, a DRX configuration, or the like. The CSI configuration(s) may be communicated via RRC signaling, MAC signaling, DCI, system information, and/or the like. In certain cases, the CSI configuration(s) may be communicated during an active time period of the DRX cycle or before the DRX cycle is configured or activated. In certain cases, an indication to enable, disable, and/or reconfigure the CSI configuration(s) may be communicated during an active time period of the DRX cycle.

The CSI configuration(s) may further indicate that communication of the CSI during the inactive time period may be independent of an on-duration timer 606 associated with the DRX cycle. Independent of the on-duration timer may mean independent of whether the on-duration timer 606 is started and/or running or not. Note that communication of the CSI during the inactive time period may occur in an instance of the DRX cycle regardless of whether the on-duration timer is started or not started.

The on-duration timer 606 may be a timer that, while running, defines at least a portion of the DRX on duration (e.g., the active time period 604) of the DRX cycle. As shown in FIG. 6, initiation of the on-duration timer 606 may start the active time period 604 of the DRX cycle. As discussed herein with respect to FIG. 5, a DRX inactivity timer may extend the DRX on duration. In certain cases, the on-duration timer may be started after a slot offset from the beginning of a subframe.

In certain cases, the UE may be configured with a monitoring occasion 608 associated with the DRX cycle. For example, the on-duration timer 606 may be started after reception of a certain wake-up signal in the monitoring occasion 608 associated with the DRX cycle. If the UE does not receive the wake-up signal in the monitoring occasion 608 (or if signaling received in the monitoring occasion is not successfully decoded), the UE may refrain from starting the on-duration timer 606, and thus, the inactive time period 602 may be extended into the duration of the on-duration timer. As an example, the wake-up signal may be or include DCI (such as DCI format 2_6) with a cyclic redundancy check (CRC) scrambled by a radio network temporary identifier (RNTI) designated for power saving (e.g., a power saving (PS)-RNTI).

In certain aspects, the CSI configuration(s) may indicate certain metric(s) or parameter(s) to include in a CSI report. The CSI configuration(s) may indicate the specific type of metric(s) and/or the number of metrics (e.g., report quantities) to include in the CSI report. For example, a CSI report may include a channel quality indicator (CQI), a precoding matrix indicator (PMI) (e.g., precoding feedback), a layer indicator (LI), a rank indicator (RI), a reference signal received power (RSRP), a signal-to-interference plus noise ratio (SINR), and/or the like. In certain aspects, the CSI report may include downlink and/or uplink channel properties. The uplink channel properties may be measured based on measurements of downlink reference signal(s), for example, when there is channel reciprocity between the downlink channel and the uplink channel. The uplink channel properties may include, for example, a power headroom report, an uplink received signal strength (e.g., RSRP), an uplink received signal quality (e.g., SINR), a transmit power backoff associated with maximum permissible exposure (MPE), a maximum allowed transmit power associated with the MPE, and/or the like. The uplink channel properties may enable communication of up-to-date CSI for uplink communications between the UE and the network entity. Accordingly, the uplink channel properties may enable reduced interruption times related to uplink beam management.

In certain aspects, the CSI configuration(s) may indicate to report CSI outside of the active time period of the DRX cycle based on reception of certain signaling, such as a wake-up signal, in the monitoring occasion 608. The signaling may be configured or specified to trigger communication of the CSI. For example, the signaling (e.g., the CRC thereof) may be scrambled with a specific RNTI designated to trigger communication of the CSI. In certain cases, the signaling may carry a payload that indicates to report CSI, such as a parameter or field in DCI. The signaling may be or include signaling used or configured for certain power saving techniques, such as the DCI scrambled with a PS-RNTI and/or a low-power wake-up signal. In certain cases, the signaling may be dedicated to triggering CSI during the inactive time period of the DRX cycle. Reception of the signaling at the UE (e.g., successfully decoding the signaling) may trigger the UE to send the CSI during the inactive time period 602 of the DRX cycle.

The monitoring occasion 608 may be a transmission time interval in which the signaling, to trigger communication of the CSI, may be communicated. In certain cases, the monitoring occasion 608 may be arranged in time before the active time period 604 of the DRX cycle, for example, in a slot adjacent to and before the active time period 604 (e.g., the previous slot with respect to the active time period). As an example, the UE may monitor for the signaling in the monitoring occasion 608, and a network entity may transmit the signaling in the monitoring occasion (e.g., to trigger communication of the CSI and/or to trigger the UE to start the on-duration timer 606).

In certain aspects, the CSI configuration(s) may indicate to report the CSI without relying on reception of certain signaling associated with the monitoring occasion 608. For example, regardless of whether a UE is configured with a monitoring occasion 608 for power savings associated with a DRX cycle, the UE may communicate the CSI at certain transmission occasion(s), as further described herein. The transmission occasion(s) may be allocated for periodic, semi-persistent, and/or aperiodic communication of CSI.

In certain aspects, the CSI configuration(s) may indicate one or more transmission occasions (hereinafter “the transmission occasion 610”) for communication of the CSI. The transmission occasion 610 may be scheduled to occur during the inactive time period 602 of the DRX cycle. The transmission occasion 610 may be arranged outside of the active time period 604. In certain cases, the transmission occasion 610 may be arranged close in time to the active time period 604 (e.g., in a previous slot) to enable communication of up-to-date CSI for any downlink communications during the active time period. Thus, communication of the CSI may enable reduced latencies and/or reduced interruption times, for example, due to the CSI being relevant for any downlink communications. In certain cases, the transmission occasion 610 may be arranged in the active time period 604 of the DRX cycle, for example, in a duration of the on-duration timer 606. In such cases, the transmission occasion 610 may be used for communication of CSI, for example, at a time during which the on-duration timer 606 is not running. In certain cases, the transmission occasion 610 may be arranged outside the duration of the on-duration timer 606.

In certain aspects, the CSI configuration(s) may indicate a resource allocation of one or more time-frequency resources (e.g., uplink channel resource(s)) for communication of the CSI in the transmission occasion 610. The time-frequency resource(s) allocated for the transmission occasion may include PUCCH resource(s) and/or time-frequency resource(s) arranged in a channel dedicated for communication of the CSI during the inactive time period of the DRX cycle. In certain cases, the time-frequency resource(s) may be shared among (e.g., configured or allocated at) multiple UEs, and the network entity may control which UE(s) communicate(s) the CSI in the respective transmission occasion, for example, via aperiodic CSI trigger(s) or the like. The shared resources may enable improved channel usage for communication of the CSI.

In certain cases, the CSI configuration(s) may indicate a time location of the transmission occasion 610 relative to the monitoring occasion 608 for the signaling configured to trigger communication of the CSI during the inactive time period of the DRX cycle. The time location of the transmission occasion 610 may be offset from the monitoring occasion 608 (or a reference time) in time. In certain cases, the monitoring occasion 608 may be an example of a reference time used to indicate the time location of the transmission occasion 610 based on a first offset 612. As an example, the reference time may be the beginning of a subframe, slot, half slot, or the like. The first offset 612 may be the time duration between the transmission occasion 610 and the monitoring occasion 608 (or reference time). In certain aspects, the first offset 612 from the monitoring occasion 608 (or reference time) may indicate the time location of the transmission occasion 610, for example, as being before the monitoring occasion 608 (e.g., via a negative value for the first offset 612) and/or after the monitoring occasion 608 (e.g., via a positive value for the first offset 612). A value of zero for the first offset 612 may indicate to communicate the CSI in the monitoring occasion 608 (or at the reference time). The duration of the first offset 612 may be in terms of a time period (e.g., milliseconds) and/or time-domain resource unit(s), such as one or more symbols, one or more slots, or the like.

In certain aspects, the CSI configuration(s) may indicate a time window 614 during which the UE is scheduled to obtain the reference signal(s). The time window 614 may have a duration, and in certain cases, the time window 614 may have a periodicity. In certain cases, the time window 614 may be configured for multiple UEs, and thus, the UEs may measure the same reference signals (e.g., group common reference signals). The group common reference signals may enable improved channel usage for communication of the reference signals for UEs with active DRX cycles, which may or may not be aligned in time. The time window 614 may be scheduled during the inactive time period 602 and/or the active time period 604 of the DRX cycle. The time window 614 may be arranged in time before or after the monitoring occasion 608 (or reference time). The time location of the time window 614 may be indicated based on a second offset 616 from the monitoring occasion (or reference time), for example, as described herein with respect to the first offset 612. The second offset 616 may be the time duration between the start of the time window 614 and the monitoring occasion 608 (or reference time). A value of zero for the second offset 616 may indicate to receive the reference signal(s) beginning at the monitoring occasion 608 (or at the reference time). The duration of the second offset 616 may be in terms of a time period (e.g., milliseconds) and/or time-domain resource unit(s), such as one or more symbols, one or more slots, or the like.

Accordingly, communication of CSI during an inactive time period of the DRX cycle may enable reduced latencies, reduced interruptions, improved channel usage, and/or the like.

### Example Signaling of Channel State Feedback in a DRX Cycle

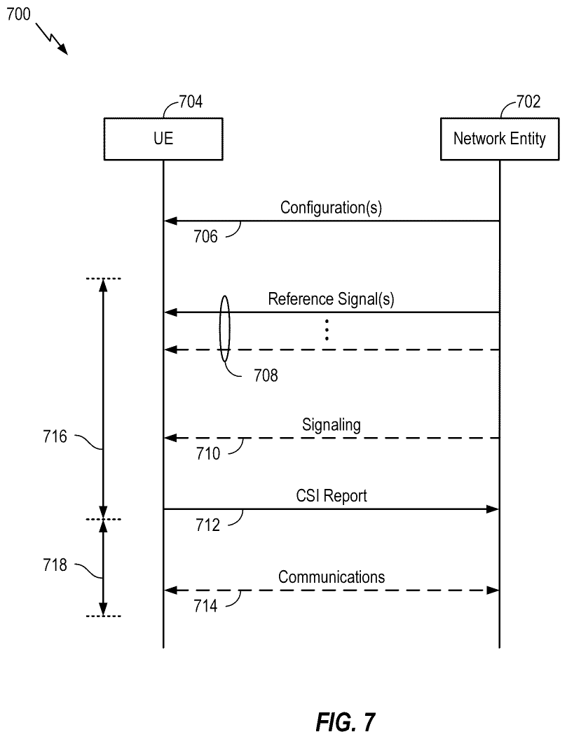

FIG. 7 depicts a process flow 700 for communication of CSI in a DRX cycle in a system between a network entity 702 and a user equipment (UE) 704. In some aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

At 706, the UE 704 obtains, from the network entity 702, one or more configurations that indicate to report CSI during an inactive time period 716 of a DRX cycle. The configuration(s) may indicate any of the aspects described herein with respect to FIG. 6. For example, the configuration(s) may indicate time-frequency resources allocated for communication of the CSI, the parameter(s) to include in a CSI report, the reference signal(s) to measure to generate the CSI, and/or the like. The configuration(s) may be communicated via RRC signaling, MAC signaling, DCI, system information, and/or the like.

At 708, the UE 704 obtains, from the network entity 702, one or more reference signals. The reference signal(s) may be or include one or more SSBs, one or more CSI-RSs, one or more DM-RSs, and/or the like. The UE 704 may obtain the reference signal(s) in a time window according to the configuration(s), for example, as described herein with respect to FIG. 6.

At 710, the UE 704 optionally obtains, from the network entity 702, certain signaling configured to trigger communication of the CSI. The signaling may be communicated in a monitoring occasion, for example, as described herein with respect to FIG. 6. The signaling may include DCI that is scrambled with a RNTI designated to trigger communication of the CSI. The signaling may include DCI that includes a field or parameter that indicates to communicate the CSI. In certain cases, the signaling may be or include a wake-up signal configured for certain power saving features.

At 712, the UE 704 sends, to the network entity 702, a CSI report that includes CSI based at least in part on the reference signal(s). The CSI report may be communicated in the inactive time period 716 of a DRX cycle, for example, according to the configuration(s). As an example, the UE 704 may determine one or more measurements based on the received reference signal(s). The CSI report may indicate one or more parameter(s) associated with the measurement(s) including, for example, one or more uplink channel properties. The uplink channel properties may enable reduced interruption times related to uplink beam management. Communication of the CSI in the inactive time period of the DRX cycle may enable reduced latencies, reduced interruption times, and/or the like.

At 714, the UE 704 communicates with the network entity 702, for example, in an active time period 718 of the DRX cycle. As an example, the CSI communicated at 712 may enable up-to-date CSI for any downlink and/or uplink communications at 714.

Note that the process flow illustrated in FIG. 7 is described herein to facilitate an understanding of communication of CSI in a DRX cycle, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Operations of Channel State Feedback in a DRX Cycle

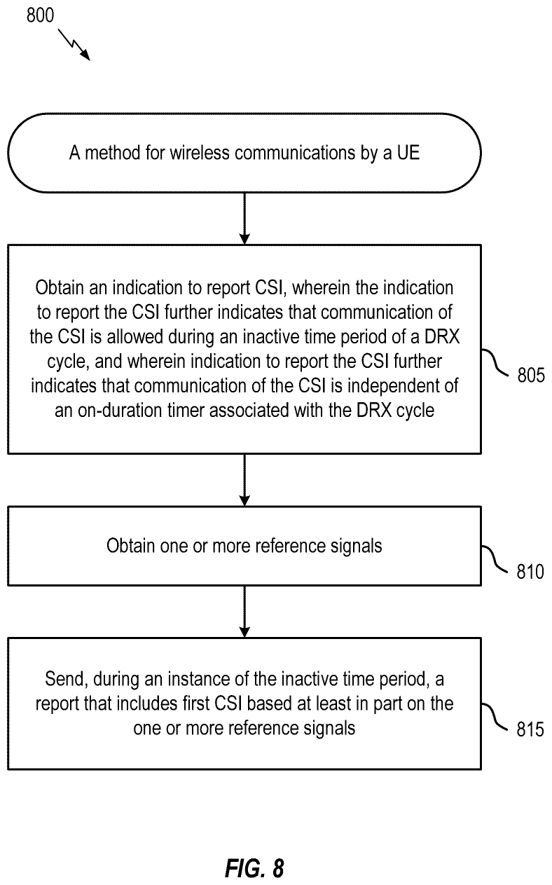

FIG. 8 shows a method 800 for wireless communications by an apparatus, such as UE 104 of FIG. 1 or UE 304 of FIG. 3.

Method 800 begins at block 805 with obtaining an indication to report CSI, wherein the indication to report the CSI further indicates that communication of the CSI is allowed during an inactive time period of a DRX cycle, and wherein the indication to report the CSI further indicates that communication of the CSI is independent of an on-duration timer associated with the DRX cycle, for example, as described herein with respect to FIGS. 6 and 7.

Method 800 then proceeds to block 810 with obtaining one or more reference signals, for example, as described herein with respect to FIGS. 6 and 7.

Method 800 then proceeds to block 815 with sending, during an instance of the inactive time period, a report that includes first CSI based at least in part on the one or more reference signals, for example, as described herein with respect to FIGS. 6 and 7.

In certain aspects, block 805 includes obtaining one or more configurations that include the indication to report the CSI.

In certain aspects, the one or more configurations further include: an indication of one or more parameters to include in the CSI; and an indication of one or more transmission occasions associated with the one or more reference signals. In certain aspects, the one or more parameters comprise one or more of: a power headroom report; an uplink received signal strength; or an uplink received signal quality.

In certain aspects, the one or more configurations further include an indication of a monitoring occasion for signaling configured to trigger communication of the CSI during the inactive time period of the DRX cycle; the method 800 further comprises obtaining the signaling in the monitoring occasion; and block 815 includes sending the report after reception of the signaling.

In certain aspects, the one or more configurations further include an indication of a transmission occasion for communication of the CSI.

In certain aspects, the indication of the transmission occasion includes an indication of a time location of the transmission occasion relative to a monitoring occasion for signaling configured to trigger communication of the CSI during the inactive time period of the DRX cycle. In certain aspects, the transmission occasion is scheduled to occur during the inactive time period of the DRX cycle. In certain aspects, the indication of the transmission occasion includes an indication of one or more time-frequency resources for communication of the CSI in the transmission occasion. In certain aspects, the one or more time-frequency resources are arranged in a channel dedicated for communication of the CSI during the inactive time period of the DRX cycle.

In certain aspects, the one or more configurations further include an indication of a time window to obtain the one or more reference signals. In certain aspects, the indication of the time window includes an indication of a start time of the time window relative to a monitoring occasion for signaling configured to trigger communication of the CSI during the inactive time period of the DRX cycle.

In certain aspects, method 800 further includes obtaining an indication to monitor for downlink signaling during an active time period of the DRX cycle. In certain aspects, method 800 further includes obtaining an indication to refrain from monitoring for the downlink signaling during the inactive time period of the DRX cycle.

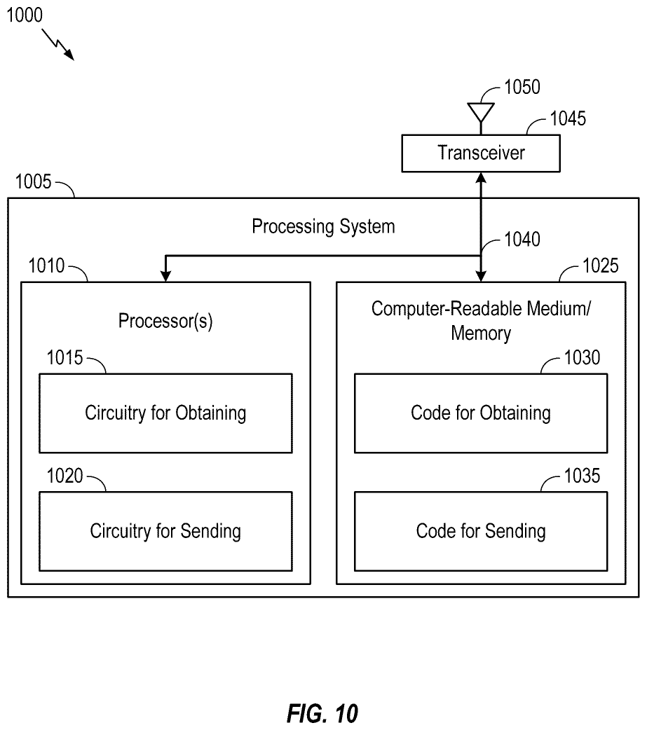

In some aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

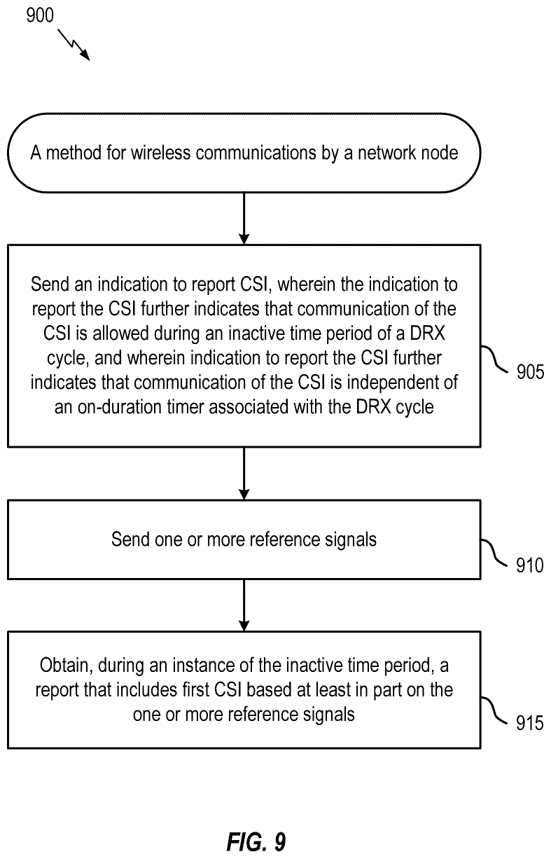

FIG. 9 shows a method 900 for wireless communications by an apparatus, such as BS 102 of FIG. 1, a first network entity 300 or second network entity 302 of FIG. 3, or a disaggregated base station as discussed with respect to FIG. 2.

Method 900 begins at block 905 with sending an indication to report CSI, wherein the indication to report the CSI further indicates that communication of the CSI is allowed during an inactive time period of a DRX cycle, and wherein the indication to report the CSI further indicates that communication of the CSI is independent of an on-duration timer associated with the DRX cycle, for example, as described herein with respect to FIGS. 6 and 7.

Method 900 then proceeds to block 910 with sending one or more reference signals, for example, as described herein with respect to FIGS. 6 and 7.

Method 900 then proceeds to block 915 with obtaining, during an instance of the inactive time period, a report that includes first CSI based at least in part on the one or more reference signals, for example, as described herein with respect to FIGS. 6 and 7.

In certain aspects, block 905 includes sending one or more configurations that include the indication to report the CSI.

In certain aspects, the one or more configurations further include: an indication of one or more parameters to include in the CSI; and an indication of one or more transmission occasions associated with the one or more reference signals. In certain aspects, the one or more parameters comprise one or more of: a power headroom report; an uplink received signal strength; or an uplink received signal quality.

In certain aspects, the one or more configurations further include an indication of a monitoring occasion for signaling configured to trigger communication of the CSI during the inactive time period of the DRX cycle; the method 900 further comprises sending the signaling in the monitoring occasion; and block 915 includes obtaining the report after reception of the signaling. In certain aspects, the one or more configurations further include an indication of a transmission occasion for communication of the CSI.

In certain aspects, the indication of the transmission occasion includes an indication of a time location of the transmission occasion relative to a monitoring occasion for signaling configured to trigger communication of the CSI during the inactive time period of the DRX cycle. In certain aspects, the transmission occasion is scheduled to occur during the inactive time period of the DRX cycle. In certain aspects, the indication of the transmission occasion includes an indication of one or more time-frequency resources for communication of the CSI in the transmission occasion. In certain aspects, the one or more time-frequency resources are arranged in a channel dedicated for communication of the CSI during the inactive time period of the DRX cycle.

In certain aspects, the one or more configurations further include an indication of a time window to obtain the one or more reference signals. In certain aspects, the indication of the time window includes an indication of a start time of the time window relative to a monitoring occasion for signaling configured to trigger communication of the CSI during the inactive time period of the DRX cycle.

In certain aspects, method 900 further includes sending an indication to monitor for downlink signaling during an active time period of the DRX cycle. In certain aspects, method 900 further includes sending an indication to refrain from monitoring for the downlink signaling during the inactive time period of the DRX cycle.

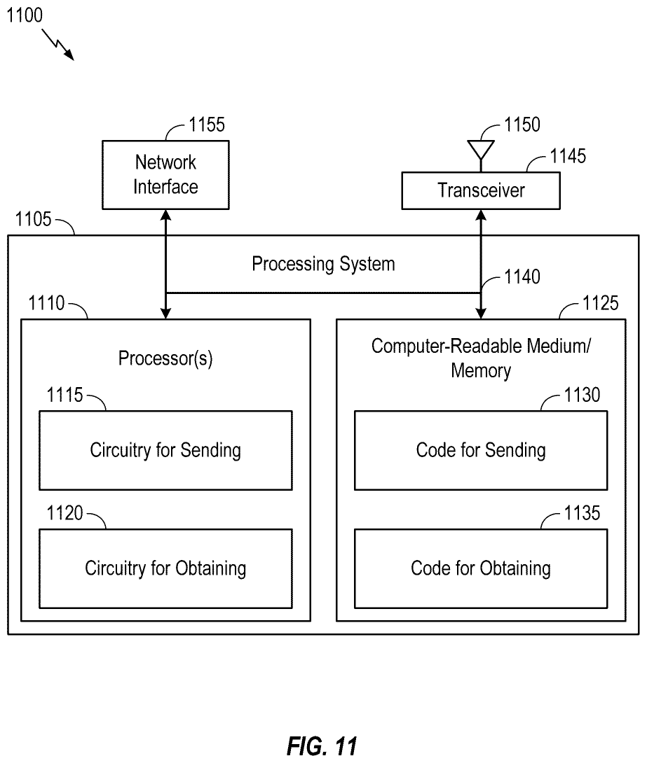

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1045 (e.g., a transmitter and/or a receiver). The transceiver 1045 is configured to transmit and receive signals for the communications device 1000 via an antenna 1050, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1025. In various aspects, the one or more processors 1010 may be representative of the one or more processors 318 described with respect to FIG. 3. The one or more processors 1010 are coupled to a computer-readable medium/memory 1025 via a bus 1040. In some aspects, the computer-readable medium/memory 1025 may be representative of the one or more memories 320 described with respect to FIG. 3. The computer-readable medium/memory 1025 is a non-transitory computer-readable medium/memory. In certain aspects, the computer-readable medium/memory 1025 is configured to store instructions (e.g., computer-executable code), that when executed by the one or more processors 1010, cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1025 stores code (e.g., executable instructions), including code for obtaining 1030 and code for sending 1035. Processing of the code 1030 and 1035 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1025, including circuitry for obtaining 1015 and circuitry for sending 1020. Processing with circuitry 1015 and 1020 may enable and cause the communications device 1000 to perform the method 800 described with respect to FIG. 8, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1045 and/or antenna 1050 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1045 and/or antenna 1050 of the communications device 1000 in FIG. 10, and/or one or more processors 1010 of the communications device 1000 in FIG. 10.

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1105 coupled to a transceiver 1145 (e.g., a transmitter and/or a receiver) and/or a network interface 1155. The transceiver 1145 is configured to transmit and receive signals for the communications device 1100 via an antenna 1150, such as the various signals as described herein. The network interface 1155 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110 and a computer-readable medium/memory 1125. In various aspects, one or more processors 1110 may be representative of the one or more processors 308, as described with respect to FIG. 3. The one or more processors 1110 are coupled to the computer-readable medium/memory 1125 via a bus 1140. In certain aspects, the computer-readable medium/memory 1125 is configured to store instructions (e.g., computer-executable code), including code 1130 and 1135, that when executed by the one or more processors 1110, cause the one or more processors 1110 to perform the method 900 described with respect to FIG. 9, or any aspect related to it, including any operations described in relation to FIG. 9. The computer-readable medium/memory 1125 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1125 stores code (e.g., executable instructions), including code for sending 1130 and code for obtaining 1135. Processing of the code 1130 and 1135 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1125, including circuitry for sending 1115 and circuitry for obtaining 1120. Processing with circuitry 1115 and 1120 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1145, antenna 1150, and/or network interface 1155 of the communications device 1100 in FIG. 11, and/or one or more processors 1110 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1145, antenna 1150, and/or network interface 1155 of the communications device 1100 in FIG. 11, and/or one or more processors 1110 of the communications device 1100 in FIG. 11.

### EXAMPLE CLAUSES

Implementation examples are described in the following numbered clauses:

Clause 1: A method for wireless communications by a UE comprising: obtaining an indication to report CSI, wherein the indication to report the CSI further indicates that communication of the CSI is allowed during an inactive time period of a DRX cycle, and wherein the indication to report the CSI further indicates that communication of the CSI is independent of an on-duration timer associated with the DRX cycle; obtaining one or more reference signals; and sending, during an instance of the inactive time period, a report that includes first CSI based at least in part on the one or more reference signals.

Clause 2: The method of Clause 1, wherein obtaining the indication to report the CSI comprises obtaining one or more configurations that include the indication to report the CSI.

Clause 3: The method of Clause 2, wherein the one or more configurations further include: an indication of one or more parameters to include in the CSI; and an indication of one or more transmission occasions associated with the one or more reference signals.

Clause 4: The method of Clause 3, wherein the one or more parameters comprise one or more of: a power headroom report; an uplink received signal strength; or an uplink received signal quality.

Clause 5: The method of Clause 2, wherein: the one or more configurations further include an indication of a monitoring occasion for signaling configured to trigger communication of the CSI during the inactive time period of the DRX cycle; the method further comprises obtaining the signaling in the monitoring occasion; and sending the report comprises sending the report after reception of the signaling.

Clause 6: The method of Clause 2, wherein the one or more configurations further include an indication of a transmission occasion for communication of the CSI.

Clause 7: The method of Clause 6, wherein the indication of the transmission occasion includes an indication of a time location of the transmission occasion relative to a monitoring occasion for signaling configured to trigger communication of the CSI during the inactive time period of the DRX cycle.

Clause 8: The method of Clause 6, wherein the transmission occasion is scheduled to occur during the inactive time period of the DRX cycle.

Clause 9: The method of Clause 6, wherein the indication of the transmission occasion includes an indication of one or more time-frequency resources for communication of the CSI in the transmission occasion.

Clause 10: The method of Clause 9, wherein the one or more time-frequency resources are arranged in a channel dedicated for communication of the CSI during the inactive time period of the DRX cycle.

Clause 11: The method of Clause 2, wherein the one or more configurations further include an indication of a time window to obtain the one or more reference signals.

Clause 12: The method of Clause 11, wherein the indication of the time window includes an indication of a start time of the time window relative to a monitoring occasion for signaling configured to trigger communication of the CSI during the inactive time period of the DRX cycle.

Clause 13: The method of any one of Clauses 1-12, further comprising: obtaining an indication to monitor for downlink signaling during an active time period of the DRX cycle; and obtaining an indication to refrain from monitoring for the downlink signaling during the inactive time period of the DRX cycle.

Clause 14: A method for wireless communications by a network node comprising: sending an indication to report CSI, wherein the indication to report the CSI further indicates that communication of the CSI is allowed during an inactive time period of a DRX cycle, and wherein the indication to report the CSI further indicates that communication of the CSI is independent of an on-duration timer associated with the DRX cycle; sending one or more reference signals; and obtaining, during an instance of the inactive time period, a report that includes first CSI based at least in part on the one or more reference signals.

Clause 15: The method of Clause 14, wherein sending the indication to report the CSI comprises sending one or more configurations that include the indication to report the CSI.

Clause 16: The method of Clause 15, wherein the one or more configurations further include: an indication of one or more parameters to include in the CSI; and an indication of one or more transmission occasions associated with the one or more reference signals.

Clause 17: The method of Clause 16, wherein the one or more parameters comprise one or more of: a power headroom report; an uplink received signal strength; or an uplink received signal quality.

Clause 18: The method of Clause 15, wherein: the one or more configurations further include an indication of a monitoring occasion for signaling configured to trigger communication of the CSI during the inactive time period of the DRX cycle; the method further comprises sending the signaling in the monitoring occasion; and obtaining the report comprises obtaining the report after reception of the signaling.

Clause 19: The method of Clause 15, wherein the one or more configurations further include an indication of a transmission occasion for communication of the CSI.

Clause 20: The method of Clause 19, wherein the indication of the transmission occasion includes an indication of a time location of the transmission occasion relative to a monitoring occasion for signaling configured to trigger communication of the CSI during the inactive time period of the DRX cycle.

Clause 21: The method of Clause 19, wherein the transmission occasion is scheduled to occur during the inactive time period of the DRX cycle.

Clause 22: The method of Clause 19, wherein the indication of the transmission occasion includes an indication of one or more time-frequency resources for communication of the CSI in the transmission occasion.

Clause 23: The method of Clause 22, wherein the one or more time-frequency resources are arranged in a channel dedicated for communication of the CSI during the inactive time period of the DRX cycle.

Clause 24: The method of Clause 15, wherein the one or more configurations further include an indication of a time window to obtain the one or more reference signals.

Clause 25: The method of Clause 24, wherein the indication of the time window includes an indication of a start time of the time window relative to a monitoring occasion for signaling configured to trigger communication of the CSI during the inactive time period of the DRX cycle.

Clause 26: The method of any one of Clauses 14-25, further comprising: sending an indication to monitor for downlink signaling during an active time period of the DRX cycle; and sending an indication to refrain from monitoring for the downlink signaling during the inactive time period of the DRX cycle.

Clause 27: One or more apparatuses, comprising: one or more memories comprising executable instructions; and one or more processors configured to execute the executable instructions and cause the one or more apparatuses to perform a method in accordance with any one of Clauses 1-26.

Clause 28: One or more apparatuses configured for wireless communications, comprising: one or more memories; and one or more processors, coupled to the one or more memories, configured to cause the one or more apparatuses to perform a method in accordance with any one of Clauses 1-26.

Clause 29: One or more apparatuses configured for wireless communications, comprising: one or more memories; and one or more processors, coupled to the one or more memories, configured to perform a method in accordance with any one of Clauses 1-26.

Clause 30: One or more apparatuses, comprising means for performing a method in accordance with any one of Clauses 1-26.

Clause 31: One or more non-transitory computer-readable media comprising executable instructions that, when executed by one or more processors of one or more apparatuses, cause the one or more apparatuses to perform a method in accordance with any one of Clauses 1-26.

Clause 32: One or more computer program products embodied on one or more computer-readable storage media comprising code for performing a method in accordance with any one of Clauses 1-26.

Clause 33: One or more apparatuses configured for wireless communications, comprising: a processing system that includes one or more processors and one or more memories coupled with the one or more processors, the processing system configured to cause the one or more apparatuses to perform a method in accordance with any one of Clauses 1-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising a processing system that includes one or more processors and one or more memories coupled with the one or more processors, the processing system configured to cause a user equipment (UE) to:
obtain an indication to report channel state information (CSI), wherein the indication to report the CSI further indicates that communication of the CSI is allowed during an inactive time period of a discontinuous reception (DRX) cycle, and wherein the indication to report the CSI further indicates that communication of the CSI is independent of an on-duration timer associated with the DRX cycle;
obtain one or more reference signals; and
send, during an instance of the inactive time period, a report that includes first CSI based at least in part on the one or more reference signals.

2. The apparatus of claim 1, wherein to obtain the indication to report the CSI, the processing system is configured to cause the UE to obtain one or more configurations that include the indication to report the CSI.

3. The apparatus of claim 2, wherein the one or more configurations further include:
an indication of one or more parameters to include in the CSI; and
an indication of one or more transmission occasions associated with the one or more reference signals.

4. The apparatus of claim 3, wherein the one or more parameters comprise one or more of:
a power headroom report;
an uplink received signal strength; or
an uplink received signal quality.

5. The apparatus of claim 2, wherein:
the one or more configurations further include an indication of a monitoring occasion for signaling configured to trigger communication of the CSI during the inactive time period of the DRX cycle;
the processing system is configured to cause the UE to obtain the signaling in the monitoring occasion; and
to send the report, the processing system is configured to cause the UE to send the report after reception of the signaling.

6. The apparatus of claim 2, wherein the one or more configurations further include an indication of a transmission occasion for communication of the CSI.

7. The apparatus of claim 6, wherein the indication of the transmission occasion includes an indication of a time location of the transmission occasion relative to a monitoring occasion for signaling configured to trigger communication of the CSI during the inactive time period of the DRX cycle.

8. The apparatus of claim 6, wherein the indication of the transmission occasion includes an indication of one or more time-frequency resources for communication of the CSI in the transmission occasion.

9. The apparatus of claim 8, wherein the one or more time-frequency resources are arranged in a channel dedicated for communication of the CSI during the inactive time period of the DRX cycle.

10. The apparatus of claim 2, wherein the one or more configurations further include an indication of a time window to obtain the one or more reference signals.

11. An apparatus, comprising a processing system that includes one or more processors and one or more memories coupled with the one or more processors, the processing system configured to cause a network node to:
send an indication to report channel state information (CSI), wherein the indication to report the CSI further indicates that communication of the CSI is allowed during an inactive time period of a discontinuous reception (DRX) cycle, and wherein the indication to report the CSI further indicates that communication of the CSI is independent of an on-duration timer associated with the DRX cycle;
send one or more reference signals; and
obtain, during an instance of the inactive time period, a report that includes first CSI based at least in part on the one or more reference signals.

12. The apparatus of claim 11, wherein to send the indication to report the CSI, the processing system is configured to cause the network node to send one or more configurations that include the indication to report the CSI.

13. The apparatus of claim 12, wherein the one or more configurations further include:
an indication of one or more parameters to include in the CSI; and
an indication of one or more transmission occasions associated with the one or more reference signals.

14. The apparatus of claim 13, wherein the one or more parameters comprise one or more of:
a power headroom report;
an uplink received signal strength; or
an uplink received signal quality.

15. The apparatus of claim 12, wherein:
the one or more configurations further include an indication of a monitoring occasion for signaling configured to trigger communication of the CSI during the inactive time period of the DRX cycle;
the processing system is configured to cause the network node to send the signaling in the monitoring occasion; and
to obtain the report, the processing system is configured to cause the network node to obtain the report after reception of the signaling.

16. The apparatus of claim 12, wherein the one or more configurations further include an indication of a transmission occasion for communication of the CSI.

17. The apparatus of claim 16, wherein the indication of the transmission occasion includes an indication of a time location of the transmission occasion relative to a monitoring occasion for signaling configured to trigger communication of the CSI during the inactive time period of the DRX cycle.

18. The apparatus of claim 16, wherein the indication of the transmission occasion includes an indication of one or more time-frequency resources for communication of the CSI in the transmission occasion.

19. The apparatus of claim 12, wherein the one or more configurations further include an indication of a time window to obtain the one or more reference signals.

20. A method of wireless communications by a user equipment (UE), comprising:
obtaining an indication to report channel state information (CSI), wherein the indication to report the CSI further indicates that communication of the CSI is allowed during an inactive time period of a discontinuous reception (DRX) cycle, and wherein the indication to report the CSI further indicates that communication of the CSI is independent of an on-duration timer associated with the DRX cycle;
obtaining one or more reference signals; and
sending, during an instance of the inactive time period, a report that includes first CSI based at least in part on the one or more reference signals.
